(19) United States
(12) Patent Application Publication
(10) Pub. No.: US 2019/0073693 A1
(43) Pub. Date: Mar. 7, 2019

(54) DYNAMIC GENERATION OF TARGETED MESSAGE USING MACHINE LEARNING

(71) Applicant: salesforce.com, inc., San Francisco, CA (US)

(72) Inventors: Ryed MOUKADDEM, Sydney (AU); Maria Kristine AMARILLO, Sandringham (AU); Tomasz OCZAPOWSKI, Sydney (AU)

(21) Appl. No.: 15/809,956

(22) Filed: Nov. 10, 2017

Related U.S. Application Data
(60) Provisional application No. 62/554,957, filed on Sep. 6, 2017.

(51) Int. Cl. G06Q 30/02; H04W 4/12; G06F 17/27; G06F 15/18; G06F 17/30

(52) U.S. Cl. CPC G06Q 30/0255; H04W 4/12; G06F 17/30241; G06F 15/18; G06F 17/2785

(57) ABSTRACT

A method by a computing device to dynamically generate a targeted message for a user. The method includes receiving a request to generate a targeted message for a user, where the request includes core content to be included in the targeted message, selecting, using machine learning, one of a plurality of templates for the targeted message based on information associated with the user, where the selected template includes a core content block and one or more additional content blocks, selecting, using machine learning, additional content to be included in the one or more additional content blocks based on information associated with the user, generating the targeted message according to the selected template and with the core content populating the core content block and with the selected additional content populating the one or more additional content blocks, and sending the targeted message for eventual transmission to a user device.

### CROSS-REFERENCE TO RELATED APPLICATIONS

This application claims the benefit of U.S. Provisional Application No. 62/554,957, filed Sep. 6, 2017, which is hereby incorporated by reference.

### TECHNICAL FIELD

One or more implementations relate to the field of customer relationship management; and more specifically, to the dynamic generation of messages targeted to a particular user.

### BACKGROUND

Customer relationship management (CRM) is a term that refers to practices, strategies, and technologies that companies/vendors use to manage and analyze customer interactions and data throughout the customer lifecycle, with the goal of improving business relationships with customers, assisting in customer retention, and driving sales growth. A CRM system is designed to compile information about customers across different channels (e.g., points of contact between the customer and the company such as the company's website, telephone, live chat, direct mail, marketing materials, and social media to name a few examples). A CRM system can also give customer-facing staff detailed information about a particular customer's personal information, purchase history, buying preferences, and concerns.

A CRM system may include a marketing automation system that is configured to generate a marketing message (e.g., advertisement) to be sent to a customer or potential customer (generally referred to herein as a “user”). The marketing automation system typically employs a rule-based engine to select a pre-defined marketing message to send to a particular user based on various attributes associated with that user such as gender, average spending, age group, last purchase, and browsing history. Typically, the rules of the rule-based engine are manually set (e.g., by a marketing team). For example, the rules may specify that users having a particular set of attributes should be sent a particular marketing message and users having different set of attributes should be sent a different marketing message. As such, this rule-based engine approach sends the same pre-structured marketing message to any two users that are alike based on their attributes.

### BRIEF DESCRIPTION OF THE DRAWINGS

The following figures use like reference numbers to refer to like elements. Although the following figures depict various exemplary implementations, alternative implementations are within the spirit and scope of the appended claims. In the drawings:

FIG. 1 is a block diagram of a system for dynamically generating a targeted message for a user, according to some implementations.

FIG. 2 is a flow diagram of a process for dynamically generating a targeted message for a user, according to some implementations.

FIG. 3 is a flow diagram of a process for using machine learning to select a template and content to populate the content blocks, according to some implementations.

FIG. 4 is a diagram illustrating a template for a targeted message, according to some implementations.

FIG. 5 is a diagram illustrating a content library, according to some implementations.

FIG. 6 is a diagram illustrating a scenario in which a targeted message for a user is dynamically generated, according to some implementations.

FIG. 7 is a diagram illustrating different targeted messages being generated for different users depending on the emotional states of the users, according to some implementations.

FIG. 8 is a block diagram of an electronic device, according to some implementations.

FIG. 9 is a block diagram of an example of an environment in which dynamic generation of targeted message for users may be used, according to some implementations.

### DETAILED DESCRIPTION

The following description describes methods and apparatus for dynamically generating a targeted message for a user. While the following description primarily refers to a marketing context where the targeted message is a marketing message (e.g., an advertisement), the techniques described herein are not so limited. It should be understood that the techniques described herein can also be applied in other contexts and can dynamically generate other types of targeted messages. As used herein, a targeted message refers to message that is customized/tailored for a particular user (e.g., a customer of a vendor). The targeted message can be dynamically generated based on information associated with the user such as purchasing behavior, demographic information, and environmental information. In some implementations, the targeted message is dynamically generated based, at least in part, on an emotional state of the user. In some implementations, the targeted message is dynamically generated using machine learning techniques. For example, machine learning techniques can be used to learn what type of message is likely to evoke a positive response from a user, and this information is utilized when dynamically generating the targeted message.

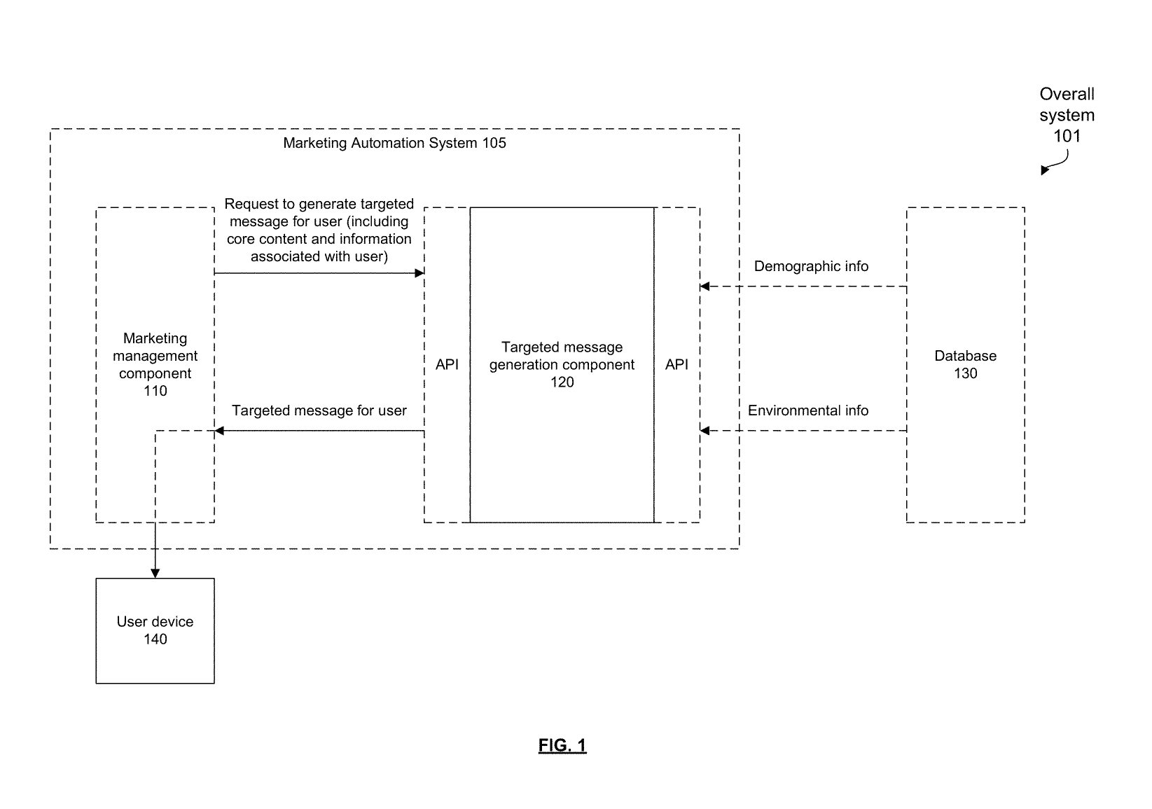

FIG. 1 is a block diagram of a system for dynamically generating a targeted message for a user, according to some implementations. As shown in the diagram, the system 101 includes a marketing automation system 105, a database 130, and a user device 140 associated with a user. The marketing automation system 105 may be communicatively coupled to the database 130 and the user device 140 over any suitable communications network. It should be understood that the system 101 is shown by way of example, and not limitation, and that the system 101 can include other elements than those shown in the diagram and have a different configuration than shown in the diagram.

The marketing automation system 105 is configured to provide one or more services for a vendor to automate their marketing campaigns. As shown in the diagram, the marketing automation system 105 includes a marketing management component 110 and a targeted message generation component 120, which are described in further detail below. In some implementations, the marketing automation system 105 is a component of a Customer Relationship Management (CRM) system. In some implementations, a vendor's eCommerce platform (not shown) interfaces with the marketing automation system 105 to access one or more services provided by the marketing automation system 105. In some implementations, the vendor's eCommerce platform and the marketing automation system 105 is integrated in the same CRM system. In some implementations, one or more services of the marketing automation system 105 are provided as cloud computing services. “Cloud computing” services provide shared resources, software, and information to computers and other devices upon request. In cloud computing environments, software can be accessible over the internet rather than installed locally on in-house computer systems. Cloud computing typically involves over-the-Internet provision of dynamically scalable and often virtualized resources. Technological details can be abstracted from the users, who no longer have need for expertise in, or control over, the technology infrastructure “in the cloud” that supports them.

The marketing management component 110 is configured to manage various aspects of a vendor's marketing campaign. For example, the marketing management component 110 may store and manage various information about users (e.g., customers of the vendor), determine the best communication channels to reach users, and determine the appropriate timing of when to send marketing materials to users. In some implementations, the marketing management component 110 may store or otherwise have access to various information associated with the user such as gender, average spending, age group, last purchase, and browsing history. In some implementations, the marketing management component 110 may have access to an indication of the current emotional state of the user. The emotional state of the user may have been determined by the marketing management component 110 or another element such as a sentiment analysis component (not shown) that can analyze the emotional state of users. Sentiment analysis may encompass the use of natural language processing, text analysis, computational linguistics, and/or biometrics to determine the emotional state of a user. The sentiment analysis may determine the current emotional state of the user, for example, based on various information known about the user such as the user's recent social media posts/activity, the user's recent browsing history, the user's current location, the weather at the user's current location, the user's heartrate (e.g., measured by the user's smart watch or fitness tracking device), and/or the music that the user is currently listening to. Examples of platforms that can be used to perform sentiment analysis include, but are not limited to, Bitext, Receptiviti, Emotient, IBM Watson, Emovu, and Internet of Things (IoT).

The targeted message generation component 120 is configured to dynamically generate targeted messages for users. As shown in the diagram, the targeted message generation component 120 interfaces with the marketing management component 110 and the database 130 via an Applications Programming Interface (API) (e.g., a Representational State Transfer (REST) API). It should be understood, however, that the targeted message generation component 120 can interface with the marketing management component 110 and the database 130 in different ways. The database 130 may store general information that is not specific to a particular user, but provides information that can be used to infer additional information about a user given certain information about the user. For example, the database 130 may store general demographic information such as the average income of an individual of a given age and living at a particular address/neighborhood. As another example, the database may store general environmental information such as the current weather conditions at a particular location. Although the diagram shows the targeted message generation component 120 as being separate from the marketing management component 110, in some implementations, the targeted message generation component 120 is integrated within the marketing management component 110.

The user device 140 is an electronic device that is associated with a user (e.g., a customer of a vendor). The user device 140 may include a desktop personal computer, workstation, laptop, smartphone, smart watch, or any other electronic device capable of interfacing directly or indirectly to the Internet or other network connection.

The interactions between the various entities shown in the diagram will now be described. As shown in the diagram, the marketing management component 110 sends a request to the targeted message generation component 120 (e.g., via an Applications Programming Interface (API)) to generate a targeted message for a user. In one implementation, the marketing management component 110 generates and sends the request in response to receiving a request from an eCommerce platform (not shown) of a vendor. In one implementation, the marketing management component 110 automatically generates and sends the request based on detecting certain pre-defined conditions (e.g., in response to detecting that a user has entered the vendor's store). The request includes core content to be included in the targeted message, as well as information associated with the user. The core content is the main content to be included in the targeted message. For example, the core content could include marketing text such as “10% off shoes, today only.” The information associated with the user may include gender, average spending, age group, last purchase, browsing history, and/or other information associated with the user that is available to the marketing management component 110 or the marketing automation system 105. In some implementations, the information associated with the user includes an indication of the current emotional state of the user (e.g., that was determined based on sentiment analysis).

In some implementations, the targeted message generation component 120 may infer further information about the user based on accessing general information from the database (e.g., via an API). For example, given the age and address of the user, the targeted message generation component 120 may access general demographic information from the database 130 to infer the income of the user. As another example, given the address or current geo-location of the user, the targeted message generation component 120 can access environmental information from the database 130 to infer the current weather condition at the user's location.

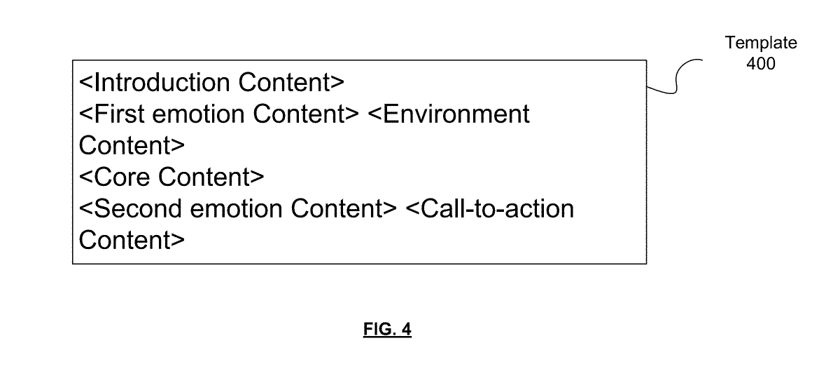

In some implementations, in response to receiving the request to generate the targeted message for the user, the targeted message generation component 120 selects a template for the targeted message based on information associated with the user, where the selected template includes a core content block and one or more additional content blocks. As used herein, a content block refers to a placeholder/container for a particular type of content. For example, the core content block is a placeholder/container for core content. In some implementations, the one or more additional content blocks include an introduction content block, an environment content block, an emotion content block, and/or a call-to-action content block. The introduction content block is a placeholder/container for introductory content (e.g., a greeting). The environment content block is a placeholder/container for content related to the environment of the user (e.g., text or image referring to the current location of the user). The emotion content block is a placeholder/container for content that appeals or relates to the current emotional state of the user. The call-to-action content block is a placeholder/container for content that encourages the user to take a particular action. An example of a template that includes a core content block and various additional content blocks is shown in FIG. 4. In some implementations, as will be described in further detail below, the targeted message generation component 120 selects the template using machine learning (e.g., using logistic regression techniques).

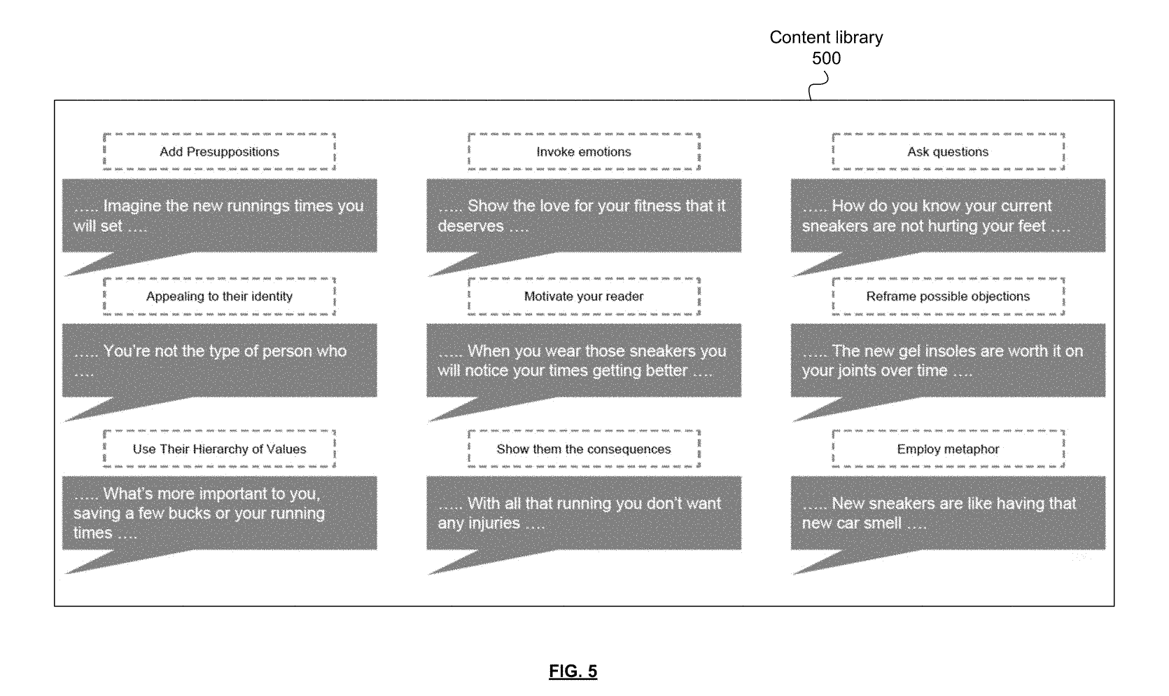

In some implementations, once the targeted message generation component 120 selects the template, the targeted message generation component 120 selects additional content (in addition to the core content) to be included in the one or more additional content blocks of the targeted message based on information associated with the user. In some implementations, the additional content can be selected from a content library. In some implementations, the content of the content library is generated based on neuro-linguistic programming (NLP) techniques. An example of a content library is shown in FIG. 5. In some implementations, as will be further described herein below, the targeted message generation component 120 selects the additional content using machine learning (e.g., using logistic regression techniques).

In some implementations, the targeted message generation component 120 selects the template for the targeted message and/or the additional content to be included in the one or more additional content blocks of the targeted message based on the current emotional state of the user (e.g., such that the structure and/or content of the targeted message appeals or relates to the current emotional state of the user).

In some implementations, once the targeted message generation component 120 selects the template and the additional content, the targeted message generation component 120 generates the targeted message according to the selected template, with the core content populating the core content block and with the selected additional content populating the one or more additional content blocks. The targeted message generation component 120 then sends the targeted message back to the marketing management component 110 (e.g., via the API). The marketing management component 110 in turn sends the targeted message for eventual transmission to the user device 140 associated with the user (e.g., via email, text, voicemail, webpage, app, etc.).

An advantage of the targeted message generation techniques described herein is that they dynamically generate a message targeted to a particular user. Unlike the rule-based engine approach that sends the same pre-structured message to any two users that have similar attributes, the targeted message generation techniques described herein dynamically select a template for the message based on information associated with the user (e.g., using machine learning). Also, this template can be dynamically populated with content based on information associated with the user (e.g., using machine learning). Thus, the message can be customized/tailored for a particular user at a more granular level than the rule-based engine approach. Another advantage of the targeted message generation techniques described herein is that they can employ machine learning to learn from the previous interactions with the user (as well as other users), and use this information to generate a message that is more likely to evoke a positive response from the user. Another advantage of the targeted message generation techniques described herein is that they can take the user's emotional state into consideration. This results in generating a more personalized message that can connect with the user on an emotional level.

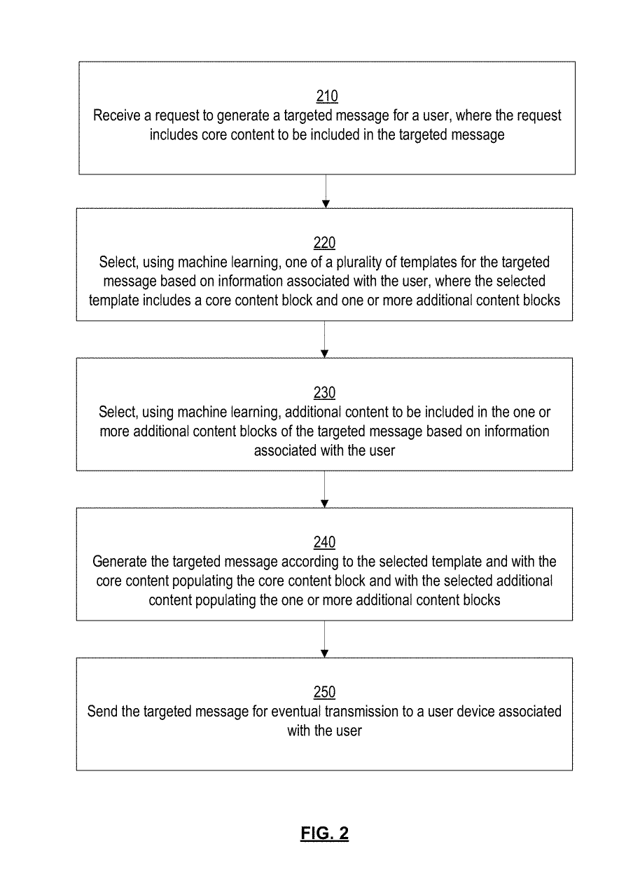

FIG. 2 is a flow diagram of a process for dynamically generating a targeted message for a user, according to some implementations. In some implementations, the process may be implemented by the targeted message generation component 120. The process can be implemented using software, hardware, firmware, or any combination thereof. The operations in the flow diagrams are be described with reference to the exemplary implementations in the other figures. However, the operations of the flow diagrams can be performed by implementations other than those discussed with reference to the other figures, and the implementations discussed with reference to these other figures can perform operations different than those discussed with reference to the flow diagrams. While the flow diagrams in the figures show a particular order of operations performed by certain implementations, it should be understood that such order is exemplary (e.g., alternative implementations may perform the operations in a different order, combine certain operations, overlap certain operations, etc.).

In some implementations, the process is initiated when the targeted message generation component 120 receives a request to generate a targeted message for a user (block 210). In some implementations, the request is received from a marketing management component 110. In some implementations, the request includes core content to be included in the targeted message. The request may also include information associated with the user such as gender, average spending, age group, last purchase, browsing history, current emotional state, and/or other information associated with the user. In some implementations, the targeted message generation component 120 infers further information about the user based on accessing general information from the database 130 such as demographic information and/or environmental information (e.g., to infer the income of the user and/or current weather condition at the user's location).

In response to receiving the request, the targeted message generation component 120 selects, using machine learning, one of a plurality of templates for the targeted message based on information associated with the user (which may include information associated with the user received as part of the request to generate the targeted message and/or inferred information about the user), where the selected template includes a core content block and one or more additional content blocks (block 220). As previously mentioned, a content block refers to a placeholder/container for a particular type of content. For example, the core content block is a placeholder/container for core content. In some implementations, the one or more additional content blocks include an introduction content block, an environment content block, an emotion content block, and/or a call-to-action content block. The introduction content block is a placeholder/container for introductory content (e.g., a greeting). The environment content block is a placeholder/container for content related to the environment of the user (e.g., text or image referring to the current location of the user). The emotion content block is a placeholder/container for content that appeals or relates to the current emotional state of the user. The call-to-action content block is a placeholder/container for content that encourages the user to take a particular action. In some implementations, the information associated with the user includes information regarding a current emotional state of the user. In some implementations, the current emotional state of the user is determined based on performing sentiment analysis for the user. In some implementations, the machine learning (that is used to select the template for the targeted message) involves logistic regression techniques.

The targeted message generation component 120 then selects, using machine learning, additional content to be included in the one or more additional content blocks of the targeted message based on information associated with the user (block 230). In some implementations, the additional content can be selected from a content library that includes a plurality of selectable content. In some implementations, the plurality of selectable content in the content library is generated based on neuro-linguistic programming (NLP) techniques. In some implementations, the machine learning (that is used to select the additional content) involves logistic regression techniques.

The targeted message generation component 120 then generates the targeted message according to the selected template and with the core content populating the core content block and with the selected additional content populating the one or more additional content blocks (block 240). The targeted message generation component 120 then sends the targeted message (e.g., to the marketing management component 110) for eventual transmission to a user device 140 associated with the user (e.g., a smart watch belonging to the user) (block 250).

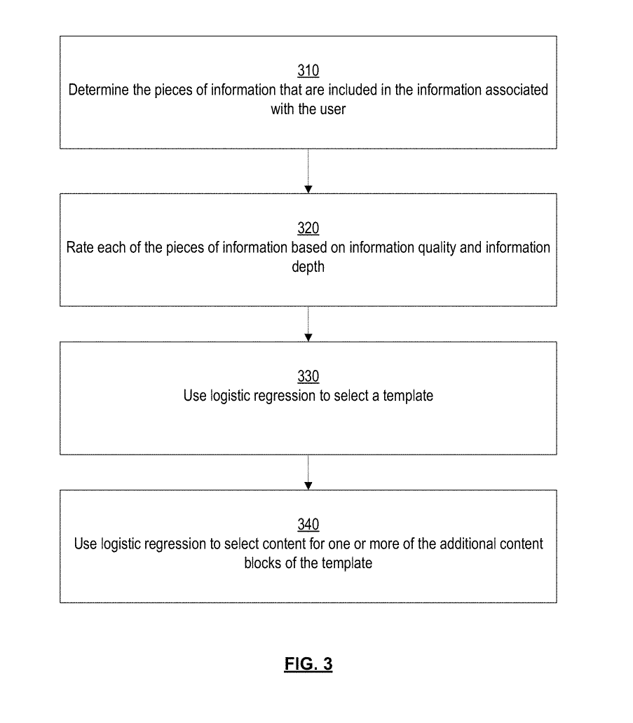

FIG. 3 is a flow diagram of a process for using machine learning to select a template and content to populate the content blocks, according to some implementations. This process may be part of the operations of blocks 220 and 230 of FIG. 2. The targeted message generation component 120 determines the pieces of information that are included in the information associated with the user (block 310). The targeted message generation component 120 then rates (e.g., assigns a numerical score) each of the pieces of information based on information quality and information depth (block 320). In some implementations, the information quality is determined based at least in part on the reliability of the information (e.g., confidence value). In some implementations, the information depth is determined based at least in part on the specificity of the information. For example, an indication that the user likes football may be considered as having greater information depth than an indication of the user's gender since it is more specific (and possibly more relevant for marketing purposes). It should be understood that the measurement of information quality and information depth can be based on other factors and can be defined differently depending on the implementation. The targeted message generation component 120 then uses logistic regression (or other suitable machine learning technique) to select a template for the targeted message (block 330). The targeted message generation component 120 may have previously learned through machine learning that users having certain attributes respond more positively to messages generated using certain templates. Thus, the targeted message generation component 120 may use logistic regression to select a template for a particular user that is most likely to evoke a positive response from that user (e.g., cause the user to purchase a product or click on a link) based on the known information associated with that user. The targeted message generation component 120 may consider the rating of certain pieces of information when determining which template to select (e.g., information with higher rating will have more influence on the selection process than information with lower rating).

Similarly, the targeted message generation component 120 may use logistic regression (or other suitable machine learning technique) to select content for one or more of the additional content blocks of the template (block 340). The targeted message generation component 120 may have previously learned through machine learning that users having certain attributes respond more positively to messages having certain content. Thus, the targeted message generation component 120 may use logistic regression to select content for one or more of the additional content blocks of the template that is most likely to evoke a positive response from that user (e.g., cause the user to purchase a product or click on a link) based on the known information associated with the user. The targeted message generation component 120 may consider the rating of certain pieces of information when determining which template to select (e.g., information with higher rating will have more influence on the selection process than information with lower rating).

FIG. 4 is a diagram illustrating a template for a targeted message, according to some implementations. As shown in the diagram, the template 400 includes various content blocks including an introduction content block, followed by a first emotion content block, followed by an environment content block, followed by a core content block, followed by a second emotion content block, and finally followed by a call-to-action content block. As previously mentioned, these content blocks are placeholders/containers for content and will be replaced/populated with actual content according to their respective types. The actual content can include text, hyperlinks, images, video, or any combination thereof. It should be understood that this is just one example of a template and that there can be additional templates that have different structures and different types of content blocks. The targeted message generation component 120 may use machine learning to select which template to use for generating the targeted message for the user (e.g., the template that is most likely to evoke a positive response from that user (e.g., cause the user to purchase a product or click on a link) based on the known information associated with the user).

FIG. 5 is a diagram illustrating a content library, according to some implementations. For purposes of illustration, a content library 500 for emotion content is shown in the diagram. It should be understood that there can be separate content libraries for other types of content as well (e.g., for introduction content, environment content, and call-to-action content). As shown in the diagram, the content library 500 includes various content that appeal to different aspects of a user's emotion. The targeted message generation component 120 may use machine learning to determine which content from the content library 500 is to populate an emotion content block of a template 400 (e.g., content that is most likely to evoke a positive response from that user (e.g., cause the user to purchase a product or click on a link) based on the known information associated with the user). For illustration purposes, the content library 500 is shown as including nine different content to choose from. However, it should be understood that the content library 500 can include more or less content to choose from than is shown in the diagram.

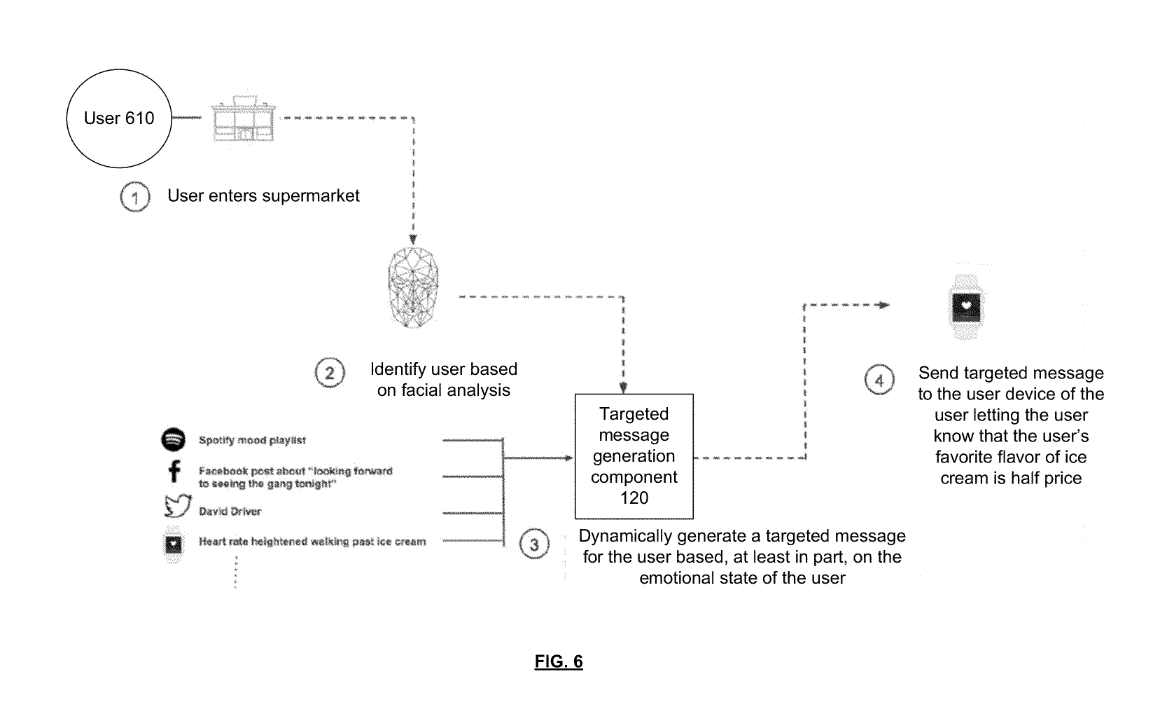

FIG. 6 is a diagram illustrating a scenario in which a targeted message for a user is dynamically generated, according to some implementations. As shown in the diagram, at step 1, the user 610 enters a supermarket. At step 2, the user 610 is identified based on facial analysis. At step 3, the targeted message generation component 120 dynamically generates a targeted message for this particular user. The targeted message for the user is dynamically generated based at least in part on the emotional state of the user such that the targeted message considers the user's current emotional state. The emotional state of the user can be determined using various means. For example, sentiment analysis can be used to determine the user's emotional state based on analyzing the user's recent social media posts, the music or playlist that the user is currently listening to, and/or the heart rate of the user. At step 4, the targeted message for the user is delivered to the user device 140 associated with the user (e.g., to the user's smart watch letting the user know that the user's favorite flavor of double chocolate ice cream is half price).

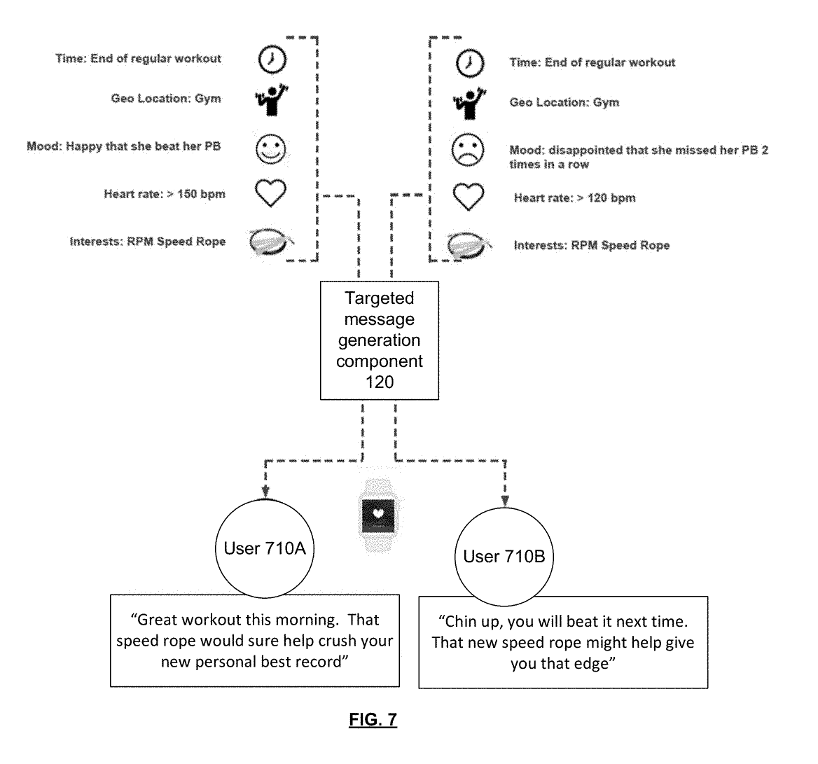

FIG. 7 is a diagram illustrating different targeted messages being generated for different users depending on the emotional states of the users, according to some implementations. As shown in the diagram, there are two users (user 710A and user 710B). Both user 710A and user 710B are at the end of their workout, at the gym, and are interested in speed ropes. However, user 710A and user 710B are currently in different emotional states. User 710A is in a happy emotional state because she just beat her personal best record. In contrast, user 710B is in a disappointed emotional state because she missed her personal best record two times in a row. The targeted message generation component 120 may capture this information (e.g., through sentiment analysis) and dynamically generate two different targeted messages for these users 710 based on their different emotional states. For example, the targeted message generation component 120 may dynamically generate a targeted message for user 710A that states, “Great workout this morning. That speed rope would sure help crush your new personal best record” and dynamically generate a targeted message for user 710B that states, “Chin up, you will beat it next time. That new speed rope might help give you that edge.” The targeted message generation component 120 thus takes each user's emotional state into consideration to generate targeted messages that can better connect with each user on an emotional level (which may lead to a higher likelihood of the user purchasing the product (e.g., the speed rope)).

One or more parts of the above implementations may include software and/or a combination of software and hardware. An electronic device (also referred to as a computing device) stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), Flash memory, phase change memory, solid state drives (SSDs)) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory (with slower read/write times, e.g., magnetic disks, optical disks, read only memory (ROM), Flash memory, phase change memory, SSDs) and volatile memory (e.g., dynamic random access memory (DRAM), static random access memory (SRAM)), where the non-volatile memory persists the code/data even when the electronic device is turned off (when power is removed), and the electronic device copies that part of the code that is to be executed by the processor(s) of that electronic device from the non-volatile memory into the volatile memory of that electronic device during operation because volatile memory typically has faster read/write times. As another example, an electronic device may include a non-volatile memory (e.g., phase change memory) to store the code/data when the electronic device is turned off, and that same non-volatile memory has sufficiently fast read/write times such that, rather than copying the part of the code to be executed into volatile memory, the code/data may be provided directly to the processor(s) (e.g., loaded into a cache of the processor(s)); in other words, this non-volatile memory operates as both long term storage and main memory, and thus the electronic device may have no or only a small amount of DRAM for main memory. Typical electronic devices also include a set of one or more physical network interface(s) to establish network connections (to transmit and/or receive code and/or data using propagating signals) with other electronic devices.

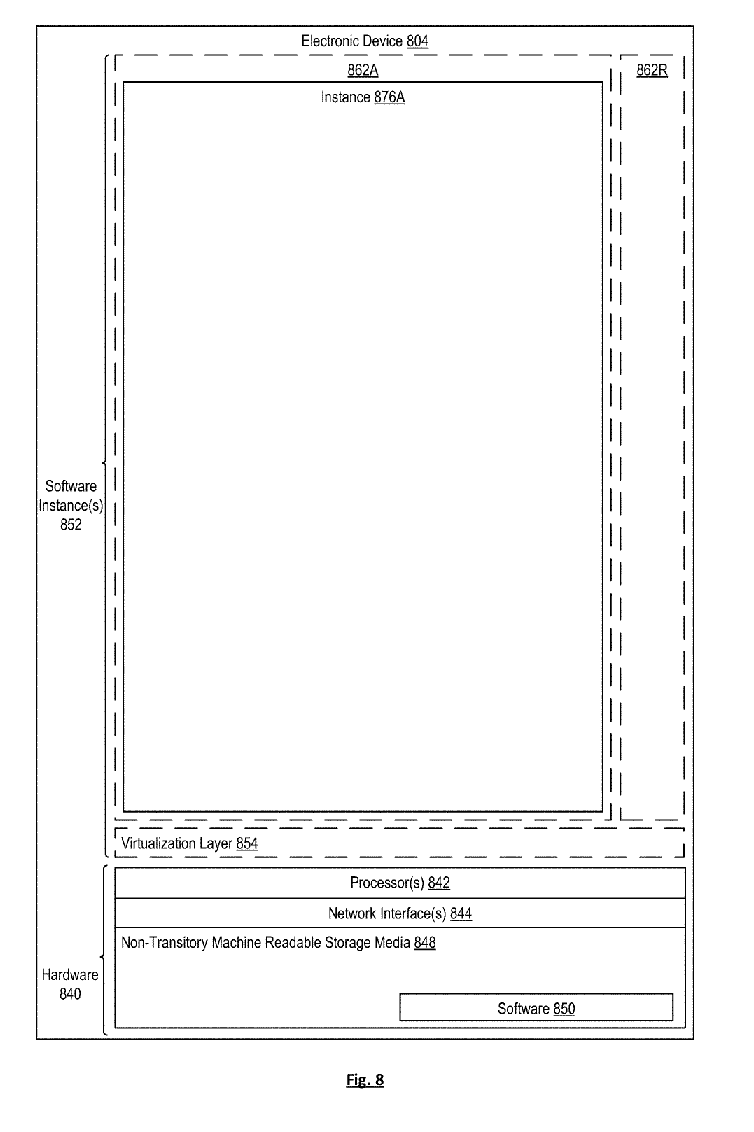

FIG. 8 is a block diagram of an electronic device 804 according to some implementations. FIG. 8 includes hardware 840 comprising a set of one or more processor(s) 842, a set or one or more network interfaces 844 (wireless and/or wired), and non-transitory machine-readable storage media 848 having stored therein software 850 (which includes instructions executable by the set of one or more processor(s) 842). Each of the previously described marketing management component 110, targeted message generation component 120, database 130, and user device 140 may be implemented in one or more electronic devices 804. In one implementation, each of the user devices 140 is implemented in a separate one of the electronic devices 804 (e.g., in an end user electronic device operated by an end user; in which case, the software 850 in each such end user electronic device includes the software to receive targeted messages (e.g., an email client, text messaging software, web browser, and/or other application that enables user device 140 to receive messages) and the marketing management component 110 and the targeted messaging component 120 are implemented in a separate set of one or more of the electronic devices 804 (in which case, the software 850 is the software to implement the marketing management component 110 and the targeted messaging component 120, respectively). Other configurations of electronic devices may be used in other implementations.

In electronic devices that use compute virtualization, the processor(s) 842 typically execute software to instantiate a virtualization layer 854 and software container(s) 862A-R (e.g., with operating system-level virtualization, the virtualization layer 854 represents the kernel of an operating system (or a shim executing on a base operating system) that allows for the creation of multiple software containers 862A-R (representing separate user space instances and also called virtualization engines, virtual private servers, or jails) that may each be used to execute a set of one or more applications; with full virtualization, the virtualization layer 854 represents a hypervisor (sometimes referred to as a virtual machine monitor (VMM)) or a hypervisor executing on top of a host operating system, and the software containers 862A-R each represent a tightly isolated form of software container called a virtual machine that is run by the hypervisor and may include a guest operating system; with para-virtualization, an operating system or application running with a virtual machine may be aware of the presence of virtualization for optimization purposes). Again, in electronic devices where compute virtualization is used, during operation an instance of the software 850 (illustrated as instance 876A) is executed within the software container 862A on the virtualization layer 854. In electronic devices where compute virtualization is not used, the instance 876A on top of a host operating system is executed on the “bare metal” electronic device 804. The instantiation of the instance 876A, as well as the virtualization layer 854 and software containers 862A-R if implemented, are collectively referred to as software instance(s) 852.

Alternative implementations of an electronic device may have numerous variations from that described above. For example, customized hardware and/or accelerators might also be used in an electronic device.

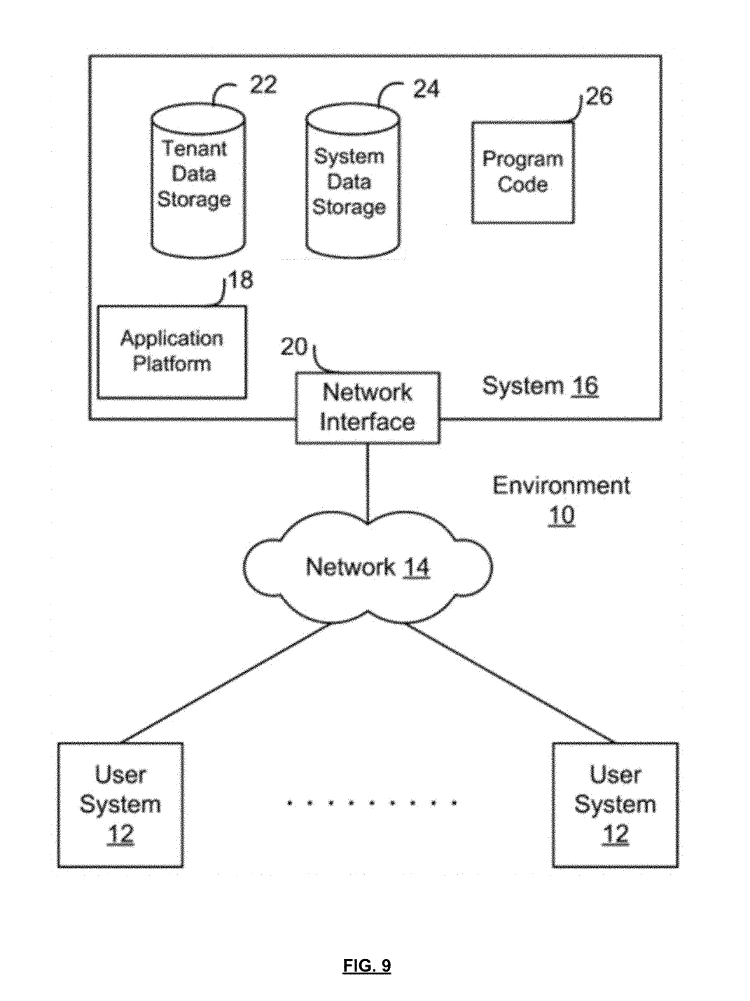

FIG. 9 shows a block diagram of an example of an environment 10 in which dynamic generation of targeted messages for users may be used in accordance with some implementations. Environment 10 may include user systems 12, network 14, and system 16, where system 16 includes application platform 18, network interface 20, tenant data storage 22, system data storage 24, and program code 26. In other implementations, environment 10 may not have all of these components and/or may have other components instead of, or in addition to, those listed above.

The system 16 includes hardware and software, and comprises the marketing automation system 105. User systems 12 are electronic devices used by one or more vendors that subscribe to services provided by the marketing automation system 105 implemented by the system 16. The services provided by the marketing automation system 105 may include the dynamic generation of targeted messages for users. User systems 12 might interact via a network 14 with the marketing management component 110 of the marketing automation system 105 implemented by the system 16. Further, in one implementation, the system 16 is a multi-tenant cloud computing architecture supporting multiple services, such as software as a service (e.g., customer relationship management (CRM) service which includes a marketing automation service (e.g., such as marketing cloud provided by salesforce.com, Inc.) that additionally includes the targeted message generation component 120), platform as a service (e.g., execution runtime, database, application development tools; such as Force.com®, Heroku™, and Database.com™ by salesforce.com, Inc.), and/or infrastructure as a service (virtual machines, servers, storage). In some implementations, such a platform as a service allows for the creation, management and execution of one or more applications developed by the provider of the marketing automation service, vendors accessing the marketing automation service via user systems 12, or third party application developers accessing the system 12.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the “Internet” with a capital “I.” The Internet will be used in many of the examples herein. However, it should be understood that the networks that the present implementations might use are not so limited, although TCP/IP is a frequently implemented protocol.

Each user system 12 is an end user electronic device, such as a desktop personal computer, workstation, laptop, Personal Digital Assistant (PDA), cell phone, etc. Each user system 12 typically includes one or more user interface devices, such as a keyboard, a mouse, trackball, touch pad, touch screen, pen or the like, for interacting with a graphical user interface (GUI) provided on a display (e.g., a monitor screen, LCD display, etc.) in conjunction with pages, forms, applications and other information provided by system 16 or other systems or servers. For example, the user interface device can be used to access data and applications hosted by system 16, and to perform searches on stored data, and otherwise allow a user to interact with various GUI pages that may be presented to a user. User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from a server at system 16 allowing a user of user system 12 to access, process and view information, pages and applications available to it from system 16 over network 14. Such a server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. However, other alternative configurations may be used instead.

In one implementation, tenant data storage 22 is a multi-tenant database management system (DBMS). In a typical multi-tenant DBMS, a single instance of software may be used to store data from multiple vendors (also known as tenants) and each vendor is provided with a dedicated share of the software instance. The term “data record” generally refers to a data entity created by or on behalf of a vendor. A data record is comprised of a set of fields defined within a database. A database can be viewed as a collection of database objects, such as a set of logical tables, containing data fitted into predefined categories. A “table” is one representation of a database object, and may be used herein to simplify the conceptual description of database objects. In the context of a relational database, each relational database table generally contains one or more data categories logically arranged as columns according to a schema, where the columns of the relational database table are different ones of the fields from the plurality of data records, and where each row of the relational database table are different ones of a plurality data records and contains an instance of data for each category defined by the fields. In some implementations of a cloud database (a database that runs on a cloud platform and access to which is provided as a database service), each database object contains a plurality of data records having fields, where identifiers are used instead of database keys, and wherein relationships are used instead of foreign keys. Regardless, by way of example, a data record can be for a business partner or potential business partner of a vendor, and can include information describing an entire company, subsidiaries, and/or contacts at the company. As another example, a data record can be for a project that a vendor is working on, such as an opportunity (e.g., a possible sale) with an existing partner, or a project that the vendor is trying to get. As another example, a CRM database may include: 1) a database object that describes a customer with fields for basic contact information such as name, address, phone number, fax number, etc.; and 2) another database object might describe a purchase order, including fields for information such as customer, product, sale price, date, etc.

In some implementations, the tenant data storage 22 includes one or more databases storing the vendor/tenant data (such as information about the vendor's customers/users, information about the vendor's products/services, marketing materials (e.g., templates 400 and content libraries 500). Thus, in operation, a vendor, through a user system 12, causes the vendor/tenant data to be stored in the tenant data storage 22. In some implementations, a vendor can access system 16 through user system 12 to access its data stored in tenant data storage 22. In some implementations, a vendor, through a user system 12, causes the system 16 to generate a targeted message for a customer/user.

In some implementations, system data storage 24 stores system data 25 accessible to system 16 and possibly multiple tenants, while program code 26 (e.g., a runtime engine that materializes application data from metadata; that is, there is a clear separation of the compiled runtime engine (also known as the system kernel), tenant data, and the metadata that describes each application, which make it possible to independently update the system kernel and tenant-specific applications and schemas, with virtually no risk of one affecting the others) for implementing various functions of system 16. In such implementations, the tenant data storage 22, which is a multi-tenant database management system (DBMS), manages one or more databases storing the vendor/tenant data and vendor/tenant application metadata. The tenant data and the system data may be stored in various databases, such as one or more Oracle® databases.

In one implementation, application platform 18 includes an application setup mechanism that supports application developers' creation and management of applications, which may be saved as metadata into tenant data storage by save routines. Invocations to such applications may be coded using PL/SOQL that provides a programming language style interface. A detailed description of some PL/SOQL language implementations is discussed in U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010. Invocations to applications may be detected by one or more system processes, which manage retrieving application metadata for the subscriber making the invocation and executing the metadata as an application in a virtual machine.

In certain implementations, one or more servers of system 16 is configured to handle requests for any user associated with any organization that is a tenant. Because it is desirable to be able to add and remove servers from the server pool at any time for any reason, there is preferably no server affinity for a user and/or organization to a specific server. In one implementation, therefore, an interface system implementing a load balancing function (e.g., an F5 Big-IP load balancer) is communicably coupled between the servers of system 16 and the user systems 12 to distribute requests to the servers. In one implementation, the load balancer uses a least connections algorithm to route user requests to the servers. Other examples of load balancing algorithms, such as round robin and observed response time, also can be used. For example, in certain implementations, three consecutive requests from the same user could hit three different servers, and three requests from different users could hit the same server. In this manner, by way of example, system 16 is multi-tenant, wherein system 16 handles storage of, and access to, different database objects, data and applications across disparate users and organizations.

In certain implementations, user systems 12 (which may be client systems) communicate with the servers of system 16 to request and update system-level and tenant-level data from system 16 that may involve sending one or more queries to tenant data storage 22 and/or system data storage 24. In one implementation of system 16, a server in system 16 automatically generates one or more SQL statements (e.g., one or more SQL queries) that are designed to access the desired information. System data storage 24 may generate query plans to access the requested data from the database.

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, teaches systems and methods for creating custom database objects as well as customizing standard database objects in a multi-tenant DBMS. In certain implementations, for example, all data records of a custom data object are stored in a single multi-tenant physical table, which may contain multiple logical database objects per organization. It is transparent to customers of the system 16 that their multiple database objects are in fact stored in one large table or that their data may be stored in the same table as the data of other customers.

In the above description, numerous specific details such as resource partitioning/sharing/duplication implementations, types and interrelationships of system components, and logic partitioning/integration choices are set forth in order to provide a more thorough understanding. It will be appreciated, however, by one skilled in the art, that the invention may be practiced without such specific details. In other instances, control structures, logic implementations, opcodes, means to specify operands, and full software instruction sequences have not been shown in detail since those of ordinary skill in the art, with the included descriptions, will be able to implement what is described without undue implementation.

References in the specification to “one implementation,” “an implementation,” “an example implementation,” “some implementations,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

In the following description and claims, the term “coupled,” along with its derivatives, may be used. “Coupled” is used to indicate that two or more elements, which may or may not be in direct physical or electrical contact with each other, co-operate or interact with each other.

The operations in the flow diagrams are be described with reference to the exemplary implementations in the other figures. However, the operations of the flow diagrams can be performed by implementations other than those discussed with reference to the other figures, and the implementations discussed with reference to these other figures can perform operations different than those discussed with reference to the flow diagrams.

While the flow diagrams in the figures show a particular order of operations performed by certain implementations, it should be understood that such order is exemplary (e.g., alternative implementations may perform the operations in a different order, combine certain operations, overlap certain operations, etc.).

While the above description includes several exemplary implementations, those skilled in the art will recognize that the invention is not limited to the implementations described and can be practiced with modification and alteration within the spirit and scope of the appended claims. The description is thus illustrative instead of limiting.

What is claimed is:

1. A method by a computing device to dynamically generate a targeted message for a user, the method comprising:
receiving a request to generate a targeted message for a user, wherein the request includes core content to be included in the targeted message;
selecting, using machine learning, one of a plurality of templates for the targeted message based on information associated with the user, wherein the selected template includes a core content block and one or more additional content blocks;
selecting, using machine learning, additional content to be included in the one or more additional content blocks of the targeted message based on information associated with the user;
generating the targeted message according to the selected template and with the core content populating the core content block and with the selected additional content populating the one or more additional content blocks; and
sending the targeted message for eventual transmission to a user device associated with the user.

2. The method of claim 1, wherein the information associated with the user includes information regarding a current emotional state of the user.

3. The method of claim 2, wherein the current emotional state of the user is determined based on performing sentiment analysis for the user.

4. The method of claim 1, wherein the information associated with the user includes information received as part of the request and information inferred about the user based on accessing general information from a database, wherein the general information includes demographic information or environmental information.

5. The method of claim 1, wherein the one or more additional content blocks include one or more of an introduction content block, an environment content block, an emotion content block, and a call-to-action content block.

6. The method of claim 1, wherein the additional content is selected from a content library that includes a plurality of selectable content.

7. The method of claim 6, wherein the plurality of selectable content in the content library is generated based on neuro-linguistic programming (NLP) techniques.

8. The method of claim 1, wherein using machine learning to select the selected template and to select the selected additional content involves using logistic regression techniques.

9. An apparatus for dynamically generating a targeted message for a user, the apparatus comprising:
a processor; and
a non-transitory machine-readable storage medium having stored therein instructions that, when executed by the processor, cause the processor to perform operations comprising:
receiving a request to generate a targeted message for a user, wherein the request includes core content to be included in the targeted message;
selecting, using machine learning, one of a plurality of templates for the targeted message based on information associated with the user, wherein the selected template includes a core content block and one or more additional content blocks;
selecting, using machine learning, additional content to be included in the one or more additional content blocks of the targeted message based on information associated with the user;
generating the targeted message according to the selected template and with the core content populating the core content block and with the selected additional content populating the one or more additional content blocks; and
sending the targeted message for eventual transmission to a user device associated with the user.

10. The apparatus of claim 9, wherein the information associated with the user includes information regarding a current emotional state of the user.

11. The apparatus of claim 10, wherein the current emotional state of the user is determined based on performing sentiment analysis for the user.

12. The apparatus of claim 9, wherein the information associated with the user includes information received as part of the request and information inferred about the user based on accessing general information from a database, wherein the general information includes demographic information or environmental information.

13. The apparatus of claim 9, wherein the one or more additional content blocks include one or more of an introduction content block, an environment content block, an emotion content block, and a call-to-action content block.

14. The apparatus of claim 9, wherein using machine learning to select the selected template and to select the selected additional content involves using logistic regression techniques.

15. A non-transitory computer-readable medium having stored therein instructions, which when executed by one or more processors of a computing device, causes the computing device to perform operations for dynamically generating a targeted message for a user, the operations comprising:
receiving a request to generate a targeted message for a user, wherein the request includes core content to be included in the targeted message;
selecting, using machine learning, one of a plurality of templates for the targeted message based on information associated with the user, wherein the selected template includes a core content block and one or more additional content blocks;
selecting, using machine learning, additional content to be included in the one or more additional content blocks of the targeted message based on information associated with the user;
generating the targeted message according to the selected template and with the core content populating the core content block and with the selected additional content populating the one or more additional content blocks; and
sending the targeted message for eventual transmission to a user device associated with the user.

16. The non-transitory computer-readable medium of claim 15, wherein the information associated with the user includes information regarding a current emotional state of the user.

17. The non-transitory computer-readable medium of claim 16, wherein the current emotional state of the user is determined based on performing sentiment analysis for the user.

18. The non-transitory computer-readable medium of claim 15, wherein the additional content is selected from a content library that includes a plurality of selectable content.

19. The non-transitory computer-readable medium of claim 18, wherein the plurality of selectable content in the content library is generated based on neuro-linguistic programming (NLP) techniques.

20. The non-transitory computer-readable medium of claim 15, wherein using machine learning to select the selected template and to select the selected additional content involves using logistic regression techniques.
